(19) United States
(12) Patent Application Publication
(10) Pub. No.: US 2023/0271443 A1
(43) Pub. Date: Aug. 31, 2023

(54) THERMAL TRANSFER SHEET AND INTERMEDIATE TRANSFER MEDIUM

(71) Applicant: TOPPAN INC., Tokyo (JP)

(72) Inventors: Shunta KAKEGAWA, Tokyo (JP); Yuki ARIGA, Tokyo (JP)

(73) Assignee: TOPPAN INC., Tokyo (JP)

(21) Appl. No.: 18/195,306

(22) Filed: May 9, 2023

Related U.S. Application Data
(63) Continuation of application No. PCT/JP2021/041627, filed on Nov. 11, 2021.

(30) Foreign Application Priority Data
Nov. 11, 2020 (JP) 2020-187964

(51) Int. Cl. B41M 5/382; B41M 5/44

(52) U.S. Cl. CPC B41M 5/38257; B41M 5/44

(57) ABSTRACT

A thermal transfer sheet is used in indirect transfer printing for forming an image through a primary transfer from the thermal transfer sheet to an intermediate transfer medium and thereafter forming an image on a transfer target through secondary transfer to the transfer target. The thermal transfer sheet includes, on a substrate, a masking layer that is a portion that prevents transfer to the transfer target during the secondary transfer. The masking layer is formed from a resin having a Tg of 140° C. or more and 220° C. or less, and the masking layer contains 0.5 wt % or more and 20 wt % or less filler particles relative to the resin.

### CROSS-REFERENCE TO RELATED PATENT APPLICATIONS

This application is a continuation application filed under 35 U.S.C. § 111(a) claiming the benefit under 35 U.S.C. §§ 120 and 365(c) of International Patent Application No. PCT/JP2021/041627, filed on Nov. 11, 2021, which in turn claims the benefit of JP 2020-187964, filed Nov. 11, 2020, the disclosures of all which are incorporated herein by reference in its entirety.

### TECHNICAL FIELD

The present invention relates to a thermal transfer sheet and an intermediate transfer medium.

### BACKGROUND

Image formation on, for example, an IC card is conventionally performed by a thermal transfer printing method using a thermal transfer sheet including a sublimation or hot-melt ink layer. For the thermal transfer printing method, indirect transfer printing is widely used specifically because of the quality of successive transfers, the versatility of transfer target materials on which images can be formed, and high reliability. The printing involves primary transfer from a thermal transfer sheet to an intermediate transfer medium and then secondary transfer from the intermediate transfer medium to a transfer target. Transfer printing that uses an intermediate transfer medium cannot easily provide a void area in a transfer area or retransfer a complicated shape to the transfer target.

For example, as shown in FIG. 5 as an IC card 20 with a signature panel 21 and a contact terminal 22 that are areas to which an image is not to be retransferred, the image receiving layer of the intermediate transfer medium may be transferred and adhere to the areas as sticking portions 24 or lie over edges of the areas as burrs 23 without being adhered. In such a case, for example, the writability of the signature panel 21 may decrease significantly, or the contact terminal 22 may cause a contact failure. Thus, there is a desire for a thermal transfer sheet including, for the purpose of reliable retransfer, a masking layer that enables a void area to be formed during retransfer from the intermediate transfer medium, and the thermal transfer sheet is further desired to form such a void area stably and precisely without producing burrs.

Such a thermal transfer sheet that allows a void area to be formed is proposed in, for example, PTL 1, which describes a thermal transfer sheet including a masking layer formed using an acrylic resin. However, the structure described in PTL 1 cannot entirely prevent transfer from the intermediate transfer medium to a void area on a transfer target, and may cause the intermediate transfer medium to adhere to an area to which the intermediate transfer medium is not to be transferred. PTL 2 proposes a thermal transfer sheet including a peel-off layer in place of the masking layer, and the thermal transfer sheet allows a void area to be formed stably by removing, from a receiving layer in an intermediate transfer medium, an area corresponding to the void area beforehand during the primary transfer. However, the structure described in PTL 2 is likely to produce burrs of the receiving layer when the receiving layer is removed to the peel-off layer, and may cause a void area to be formed in an area to which the intermediate transfer medium is to be transferred.
[Citation List] [Patent Literature] [PTL 1] JP 2002-254839 A; [PTL 2] JP 2003-326865 A.

### SUMMARY OF THE INVENTION

### Technical Problem

The present invention has been made in view of such circumstances and provides a thermal transfer sheet including a masking layer and which is used for thermal transfer image formation, and an intermediate transfer medium used in the thermal transfer image formation. The thermal transfer sheet enables transfer from the intermediate transfer medium to a transfer target while forming a void area with no sticking of the intermediate transfer medium to the void area and with no burrs formed on the edge of the void area.

### Solution to Problem

A first aspect of the present invention is a thermal transfer sheet used in indirect transfer printing for forming an image through primary transfer from the thermal transfer sheet to an intermediate transfer medium and thereafter forming an image on a transfer target through secondary transfer to the transfer target, the thermal transfer sheet comprising: a masking layer on a substrate, the masking layer being a portion that prevents transfer to the transfer target during the secondary transfer, wherein the masking layer is formed from a resin having a Tg of 140° C. or more and 220° C. or less, and the masking layer contains 0.5 wt % or more and 20 wt % or less filler particles relative to the resin.

A second aspect of the present invention is the thermal transfer sheet according to the first aspect, in which the filler particles contained in the masking layer may have a particle diameter of 0.1 μm or more and 5 μm or less.

A third aspect of the present invention is the thermal transfer sheet according to the first or second aspect, in which the masking layer may have a thickness of 0.1 μm or more and 3 or less.

A fourth aspect of the present invention is the thermal transfer sheet according to any one of the first to third aspects, in which the masking layer and a plurality of color thermal transfer ink layers may be sequentially arranged across a surface of the substrate.

A fifth aspect of the present invention is an intermediate transfer medium comprising: a substrate; and at least an intermediate layer and an image receiving layer laminated sequentially on one surface of the substrate, wherein the intermediate transfer medium forms an image through primary transfer from a sublimation ink layer or a hot-melt ink layer in a thermal transfer sheet to the image receiving layer, thereafter forming an image on a transfer target through secondary transfer to the transfer target, the intermediate transfer medium includes a masking layer formed for the image receiving layer, the masking layer being a portion that prevents transfer to the transfer target and is peeled from the image receiving layer through the secondary transfer after the image is formed from the ink layer onto the image receiving layer, the masking layer is formed from a resin having a Tg of 140° C. or more and 220° C. or less, and the masking layer contains 0.5 wt % or more and 20 wt % or less filler particles relative to the resin.

A sixth aspect of the present invention is the intermediate transfer medium according to the fifth aspect, in which the intermediate transfer medium may further include a peeling layer between the substrate and the intermediate layer.

A seventh aspect of the present invention is the intermediate transfer medium according to the fifth or sixth aspect, in which the filler particles contained in the masking layer may have a diameter of 0.1 μm or more and 5 μm or less.

An eighth aspect of the present invention is the intermediate transfer medium according to any one of the fifth to seventh aspects, in which the masking layer may have a thickness of 0.1 μm or more and 3 μm or less.

### Advantageous Effects of the Invention

When a void area is formed during thermal transfer image formation on a transfer target using an intermediate transfer medium, the thermal transfer sheet provided according to the present invention prevents sticking of the intermediate transfer medium onto the void area and burrs on an edge of the void area.

That is, the thermal transfer sheet used in indirect transfer printing according to the present invention can reduce burrs and untransferred portions produced particularly during retransfer to a transfer target after a thermal transfer image is formed on the image receiving layer of the intermediate transfer medium (primary transfer).

### BRIEF DESCRIPTION OF THE DRAWINGS

FIG. 1 is a cross-sectional view illustrating an example thermal transfer sheet according to the present embodiment.

FIG. 2A is a cross-sectional view illustrating an example structure of a color thermal transfer sheet according to the present embodiment.

FIG. 2B is a cross-sectional view illustrating an example structure of an intermediate transfer medium according to the present embodiment.

FIG. 3A illustrates the transfer process using the thermal transfer sheet according to the present embodiment.

FIG. 3B illustrates the transfer process using the thermal transfer sheet according to the present embodiment.

FIG. 3C illustrates the transfer process using the thermal transfer sheet according to the present embodiment.

FIG. 3D illustrates the transfer process using the thermal transfer sheet according to the present embodiment.

FIG. 4A is a plan view illustrating an example structure of a thermal transfer sheet according to the present embodiment.

FIG. 4B is a plan view illustrating another example structure of a thermal transfer sheet according to the present embodiment.

FIG. 5 illustrates the shapes of burrs and untransferred portions.

FIG. 6A is a schematic diagram illustrating primary transfer using an intermediate transfer medium according to another embodiment.

FIG. 6B is a schematic diagram illustrating secondary transfer using an intermediate transfer medium according to another embodiment.

### DETAILED DESCRIPTION

With reference to the drawings, some embodiments of the present disclosure will be described in detail. It should be noted that, in the drawings, like or corresponding parts are designated with like reference signs to avoid duplicate description. The positional relationship between left, right, top and bottom is based on the positional relationship shown in the drawings unless otherwise specified. The dimensional ratios in the drawings are not limited to those shown therein. However, the present invention is not limited to the embodiments described below. In the embodiments provided below, although technically preferable limitations are shown in implementing the invention, the limitations are not essential to the present invention.

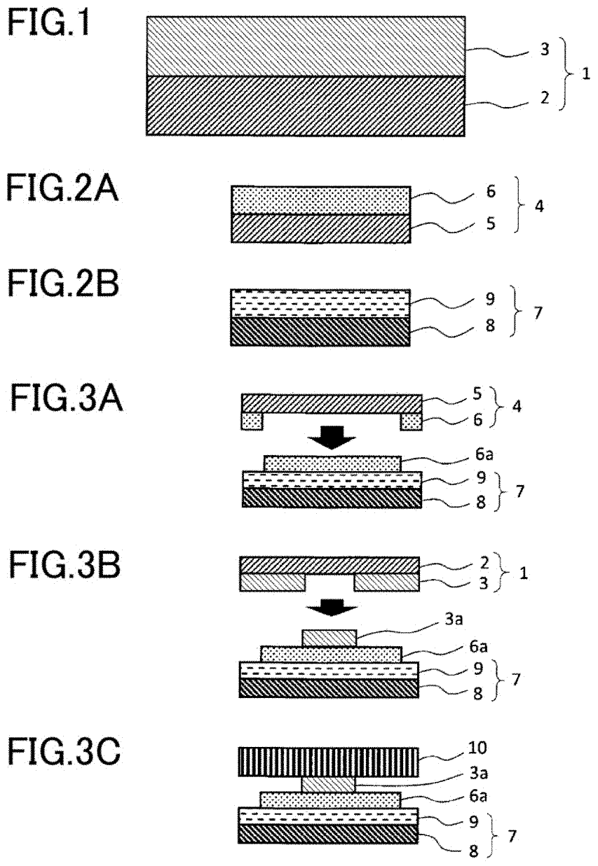

FIG. 1 is a cross-sectional view illustrating an example thermal transfer sheet according to the present embodiment. A thermal transfer sheet 1 includes a masking layer 3 provided on one surface of a substrate 2. When an image is formed on a transfer target by indirect transfer printing using a thermal transfer sheet according to the present embodiment, the image formation is performed by using the thermal transfer sheet 1 including the masking layer 3, a color thermal transfer sheet 4 including a color thermal transfer ink layer 6 provided on a substrate 5 as illustrated in FIG. 2A, and an intermediate transfer medium 7 including an image receiving layer 9 provided on a substrate 8 as illustrated in FIG. 2B. The thermal transfer sheet 1 and the color thermal transfer sheet 4 may have a structure formed by separately applying their layers onto the same substrate as described later.

The substrate 2 is not limited to a particular substrate but may be any substrate used for a conventional thermal transfer sheet. Specific examples of preferable substrates 2 include polyethylene terephthalate, polyethylene naphthalate, polypropylene, cellophane, acetate, polycarbonate, polysulfone, polyimide, polyvinyl alcohol, aromatic polyamide, aramid, polystyrene, and other synthetic resin films and capacitor paper, paraffin paper, and other paper, which may be used alone or in combination as a composite. Although the substrate 2 may have a thickness determined as appropriate depending on the material so as to provide sufficient strength and heat resistance, the thickness is typically 2 μm or more and 50 μm or less, and preferably about 2 μm or more and 9 μm or less in view of suitability for transfer and handling properties such as processability.

The substrate 2 may also include a heat-resistant slipping layer (not shown) on the surface on which the masking layer 3 is not provided in order to provide heat resistance and lubricity that allows smoother feeding in contact with a heater such as a thermal head during printing. Additionally, the surface with the masking layer 3 on it may be subjected to adhesion treatment. The heat-resistant slipping layer may be a conventionally known heat-resistant slipping layer and formed by, for example, preparing, applying, and drying a coating liquid for forming a heat-resistant slipping layer. The coating liquid is prepared by mixing a binder resin, a functional additive that provides releasability and lubricity, a filler, a curing agent, a solvent, and the like. The adhesion treatment may be a known technique such as corona treatment, flame treatment, ozone treatment, ultraviolet treatment, radiation treatment, roughening treatment, plasma treatment, or primer treatment, and two or more of the treatments may be used in combination.

The masking layer 3 is formed by preparing, applying, and drying a coating liquid for forming a masking layer. The coating liquid is prepared by mixing a binder resin, filler particles, a solvent, and the like. In the masking layer according to the present embodiment, the binder resin has a Tg of 140° C. or more and 220° C. or less, and 0.5 wt % or more and 20 wt % or less filler particles are contained.

When the Tg of the binder resin is less than 140° C., the heat and pressure during retransfer from the intermediate transfer medium 7 to a transfer target may melt and transfer the masking layer 3. When the Tg exceeds 220° C., the masking layer 3 cannot be easily transferred from the thermal transfer sheet 1 to the intermediate transfer medium 7, resulting in incomplete masking.

When the weight percentage of the filler particles is less than 0.5%, the addition of the filler brings about no effect. When the weight percentage exceeds 20%, the masking layer 3 is likely to decrease in adhesiveness and cause poor transfer, and is liable to break easily to cause rub-off.

Examples of the binder resin include, but not limited to, a cellulose acetate resin, a polyarylate resin, a polysulfone resin, a polyphenylsulfone resin, a polyethersulfone resin, a polyetherimide resin, a polyaryl ether ketone resin, and a polyether ether ketone resin.

The masking layer 3 preferably has a dry thickness of 0.1 μm or more and 3 μm or less, and the contained filler particles preferably have a diameter of 0.1 μm or more and 5 μm or less. Regarding the type of the filler particles, a conventionally known material may be used, or specifically, silica filler, silicone filler, organic polymer filler, or inorganic filler may be used.

The masking layer 3 and the heat-resistant slipping layer may each be applied and formed by a conventionally known application method, such as gravure coating, screen printing, spray coating, or reverse roll coating.

<Intermediate Transfer Medium>

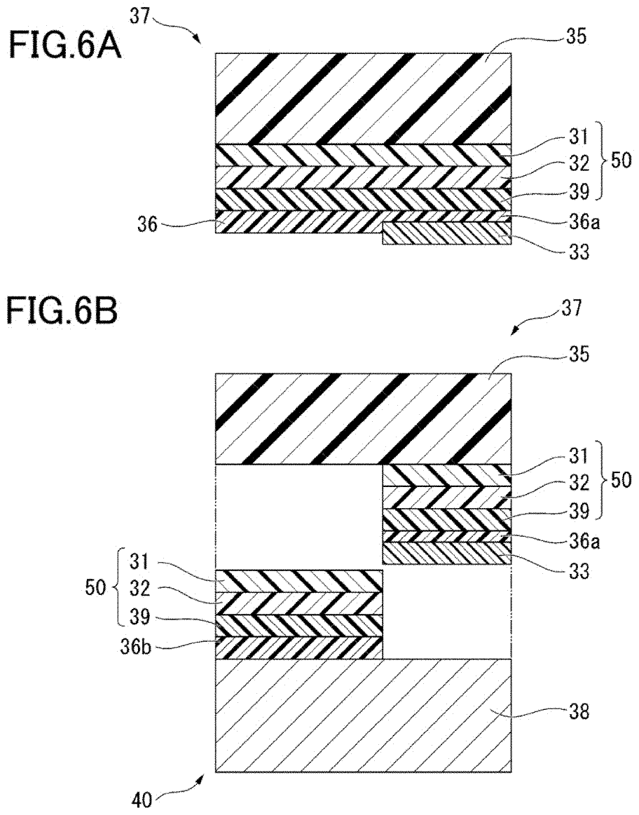

With reference to FIG. 6A, an intermediate transfer medium 37 according to the present embodiment will now be described. As shown in FIG. 6A, the intermediate transfer medium 37 according to the present invention includes, on one surface of a substrate 35, a transfer layer 50 peelable from the substrate 35. The transfer layer 50 has a basic structure with an intermediate layer 32 and an image receiving layer 39 laminated in this order from the substrate 35 side. In the intermediate transfer medium 37 according to the present invention, the transfer layer 50 may include a peeling layer 31 or a release layer (not shown), or both the peeling layer 31 and a release layer (not shown) between the substrate 35 and the intermediate layer 32. Alternatively, the substrate 35 may include a release layer (not shown).

In addition, a heat-resistant slipping layer (not shown) may be provided on the other surface of the substrate 35 to improve heat resistance and smoothness of feeding when in contact with a heater such as a thermal head during printing. The heat-resistant slipping layer may be any layer having heat resistance.

Additionally, the image receiving layer 39 may be formed with an adhesive layer (not shown) provided on the intermediate layer 32.

Each component of the intermediate transfer medium 37 according to the present invention is described in detail below.

(Substrate)

The substrate 35 holds the transfer layer 50 on one surface and optionally the heat-resistant slipping layer on the other surface of the substrate 35. Preferably, the substrate 35 transmits ultraviolet (UV) wavelength light used for an ultraviolet (UV) curing reaction of the intermediate layer 32 included in the transfer layer 50, and has heat resistance against a heating temperature for thermal transfer to a transfer target and mechanical characteristics that will not interfere with a transfer process. Examples of materials that can be used for the substrate 35 include, but not limited to, polyesters such as polyethylene terephthalate, polyarylate, polycarbonate, polyurethane, polyimide, polyetherimide, cellulose derivatives, polyethylene, ethylene-vinyl acetate copolymers, polypropylene, polystyrene, acryl, polyvinyl chloride, polyvinylidene chloride, polyvinyl alcohol, polyvinyl butyral, nylon, polyether ether ketone, polysulfone, polyethersulfone, tetrafluoroethylene-perfluoroalkyl vinyl ether, polyvinyl fluoride, tetrafluoroethylene-ethylene, tetrafluoroethylene-hexafluoropropylene, polychlorotrifluoroethylene, and polyvinylidenefluoride. The substrate 35 is used in the form of a film or a sheet of these various plastics. The substrate 35 has a thickness that can be determined as appropriate in accordance with various plastics so as to ensure the strength and the heat resistance of the substrate 35. The thickness may be, for example, 2.5 μm to 100 μm.

The substrate 35 may be subjected to adhesion treatment on the surface adjacent to the intermediate layer 32 and the image receiving layer 39 or on both surfaces. The adhesion treatment may be a known technique such as corona treatment, flame treatment, ozone treatment, ultraviolet treatment, radiation treatment, roughening treatment, plasma treatment, or primer treatment, and two or more of the treatments may be used in combination.

A heat-resistant slipping layer (not shown) may be provided on the surface of the substrate 35 on which the intermediate layer 32 and the image receiving layer 39 are not formed.

(Intermediate Layer)

The intermediate layer 32 included in the transfer layer 50 is a layer containing, as a main component, an acrylic polyol resin cured under heat with polyisocyanate.

The polyisocyanate is preferably xylylene diisocyanate (XDI) or hexamethylene diisocyanate (HDI).

The intermediate layer 32 is formed by mixing polyisocyanate and an acrylic polyol resin so that the equivalent ratio between the isocyanate groups and the hydroxyl groups (NCO/OH) is 1.0 or more and 4.0 or less, followed by heat curing. The present inventors have found by research that when NCO/OH is less than 1.0, the curing reaction may progress insufficiently and thus result in insufficient durability, and when NCO/OH is more than 4.0, the hard coating contains a large amount of unreacted curing agent, which may lower the durability.

Alternatively, the intermediate layer 32 may be a layer having a cross-linked structure formed through an ultraviolet (UV) curing reaction of a composition of an ultraviolet (UV) reactive acrylate resin and a photopolymerization initiator.

The ultraviolet (UV) reactive acrylate resin may be a material composed of a bifunctional acrylate or bifunctional methacrylate and tri- or higher functional polyfunctional acrylate or tri- or higher functional polyfunctional methacrylate. The UV reactive acrylate resin is preferably a bifunctional acrylate.

The photopolymerization initiator may be a radical initiator such as an alkylphenone initiator, an acylphosphine oxide initiator, or an oxyphenylacetate initiator or a cationic initiator such as an iodonium salt initiator or a sulfonium salt initiator.

The intermediate layer 32 contains a filler. The addition of the filler can improve the foil-tearing properties during transfer and the durability of a transferred image without degrading the smoothness, transparency, and glossiness of the intermediate layer 32.

In the present embodiment, the amount of the filler is 0.5% by mass or more and 25% by mass or less of the weight of the acrylic polyol resin. The present inventors have found by research that when the amount of filler in an intermediate layer containing an acrylic polyol resin as a main component is within the above range, the foil-tearing properties during transfer and the durability of a transferred image are particularly excellent.

The filler may be made of a conventionally known material, and any of an organic filler, an inorganic filler, and an organic-inorganic hybrid filler may be suitably used. These fillers may be a powder or sol. Examples of powdery organic fillers include acrylic particles such as non-crosslinked acrylic particles and crosslinked acrylic particles, melamine particles, polyamide particles, silicone particles, and polyethylene wax. Examples of powdery inorganic fillers include calcium carbonate particles, silica particles, and metal oxide particles such as titanium oxide. Examples of the organic-inorganic hybrid fillers include a hybrid of an acrylic resin and silica particles. Examples of the sol fillers include silica sol and organosol fillers. These fillers may be used alone or in combination of two or more.

The filler particle diameter is not limited to a particular diameter but may be 0.01 μm or more and 3 μm or less. Within the above range, it is preferable for release during transfer, and film formation.

In the present embodiment, the phrase “filler particle diameter” refers to the mean volume diameter. The filler particle diameter may be measured by, for example, analyzing results obtained by the BET method and observations under an electron microscope using image analysis software for particle size distribution measurement.

It is noted that some filler particles having a diameter out of the above range may be contained unless they interfere with the effect of the filler.

The intermediate layer 32 may contain resin components other than the acrylic polyol resin as an added resin. The present inventors have found by research that the intermediate layer 32 containing the acrylic polyol resin as a main component and one or both of a polyester resin and an epoxy resin has good adhesion to the substrate 35 and the image receiving layer 39.

The amount of the added resin may be 1% or more and 30% or less of the acrylic polyol resin.

(Peeling Layer)

In the transfer layer 50 with the intermediate layer 32 formed on the substrate 35, when the intermediate layer 32 has insufficient transferability and foil-tearing properties, it is preferable to provide the peeling layer 31 as shown in FIGS. 6A and 6B. This can improve the transferability and the foil-tearing properties of the transfer layer 50, ensuring that the intermediate layer 32 produces its effect to provide high durability to the resultant print.

The peeling layer 31 is preferably made from a resin with appropriately adjusted adhesiveness to the substrate 35. Excessively high adhesiveness may prevent the transfer layer 50 from being transferred from the substrate to the surface of the transfer target when the substrate is peeled after a thermal transfer. Excessively low adhesiveness may leave burrs on an edge of the transfer target after the substrate is peeled.

Examples of resins having appropriate adhesiveness and suitable for the peeling layer 31 included in the transfer layer 50 include thermally fusible polystyrene, acrylic resins such as polymethyl methacrylate and polyethyl acrylate, vinyl resins such as polyvinyl chloride, polyvinyl acetate, vinyl chloride-vinyl acetate copolymers, polyvinyl butyral and polyvinyl acetal, polyester resins, polyamide resins, epoxy resins, polyurethane resins, waxes such as paraffin wax, cellulose derivatives, and mixtures of these resins. In particular, acrylic resins and cellulose derivatives are preferable. Additionally, various additives may be contained as appropriate in order to provide lubricity and adjust the surface gloss.

The adhesiveness may be adjusted using known materials. Excessively low adhesiveness may be adjusted by adding a thermoplastic resin or an adhesive, whereas excessively high adhesiveness may be adjusted by adding a material that does not contribute to adhesion into the peeling layer 31.

(Image Receiving Layer)

As shown in FIG. 6A, the image receiving layer 39 is disposed on the intermediate layer 32. The image receiving layer 39 is a layer included in the transfer layer 50. A thermal transfer image 36a is formed on the image receiving layer 39. The image receiving layer 39 with the image 36a formed on it is transferred together with the intermediate layer 32 and also the peeling layer 31 to a transfer target 40 to form a print. The image receiving layer 39 may be formed from a conventionally known resin that is receptive to a thermally transferable colorant such as a sublimation dye or a thermally fusible transfer ink.

Examples of resins for forming the image receiving layer 39 include polyolefin resins such as polypropylene, halogenated resins such as polyvinyl chloride or polyvinylidene chloride, vinyl resins such as polyvinyl acetate, vinyl chloride-vinyl acetate copolymers, ethylene-vinyl acetate copolymers, or polyacrylic esters, polyester resins such as polyethylene terephthalate or polybutylene terephthalate, polystyrene resins, polyamide resins, copolymer resins of an olefin such as ethylene or propylene and another vinyl polymer, ionomers, cellulose resins such as cellulose diacetate, polycarbonates, and epoxy resins. In particular, vinyl chloride resins, acrylic styrene resins, or polyester resins are preferable for transfer with a sublimation thermal transfer ribbon, whereas epoxy resins are preferable for transfer with a hot-melt thermal transfer ribbon.

In the case that the image receiving layer 39 is transferred to a transfer target with an adhesive layer, the image receiving layer 39 itself may not necessarily have adhesiveness. However, in the case that the image receiving layer 39 is transferred to a transfer target without an adhesive layer, it is preferable to form the image receiving layer 39 using an adhesive resin.

The image receiving layer 39 may be formed by preparing a coating liquid for the receiving layer by dissolving or dispersing one or more materials selected from the above materials and various optional additives in an appropriate solvent such as water or an organic solvent, and applying and drying the resultant coating liquid by solvent coating such as bar coating, blade coating, air knife coating, gravure coating, or roll coating. The image receiving layer 39 may have a thickness of preferably 0.1 μm or more and 10 μm or less and more preferably about 0.2 μm or more and 8 μm or less.

For an image receiving layer 39 that has no adhesiveness, an adhesive layer (not shown) may be provided on the image receiving layer 39. Although an adhesive layer is unnecessary for a transfer target subjected to an adhesion treatment, such an adhesive layer may optionally be provided.

Examples of resins for forming the adhesive layer include a conventionally known adhesive containing an acrylic resin, a vinyl resin, a polyester resin, a urethane resin, a polyamide resin, an epoxy resin, a rubber resin, or an ionomer resin as a main component.

(Heat-Resistant Slipping Layer)

An optional heat-resistant slipping layer (not shown) can be provided on the other surface of the substrate 35 to improve heat resistance and smoothness of feeding when in contact with a heater such as a thermal head during printing.

Examples of materials for the heat-resistant slipping layer include cellulose resins, polyester resins, acrylic resins, vinyl resins, polyurethane resins, polyether resins, polycarbonate resins, and acetal resins containing lubricant such as fluororesins, silicone resins, silicone oils, polyethylene waxes or phosphate, and modified silicone resins. In addition, fillers such as silica, calcium carbonate, talc, and resin beads may be contained, and a cross-linking agent may also be used in order to improve the heat resistance.

The heat-resistant slipping layer may be formed by preparing a coating liquid for the heat-resistant slipping layer by dissolving or dispersing one or more materials selected from the above materials and various optional additives in an appropriate solvent such as water or an organic solvent, and applying and drying the resultant coating liquid by solvent coating such as bar coating, blade coating, air knife coating, gravure coating, or roll coating. The heat-resistant slipping layer may have a coating thickness of preferably 0.1 μm to 4 μm.

With reference to FIGS. 3A to 3D, a transfer process using the thermal transfer sheet according to the present embodiment will now be described.

First, as shown in FIG. 3A, an indirect transfer printer causes the color thermal transfer ink layer 6 of the color thermal transfer sheet 4 to face the image receiving layer 9 of the intermediate transfer medium 7, and forms an image 6a including a predetermined color picture and characters on the image receiving layer 9.

Then, as shown in FIG. 3B, the masking layer 3 of the thermal transfer sheet 1 is caused to face the image receiving layer 9 of the intermediate transfer medium 7 on which the image 6a is formed, and a masking layer 3a is transferred to an area to be masked. Then, as shown in FIG. 3C, the image receiving layer 9 with the masking layer 3a and the image 6a formed is caused to face a transfer target 10 and transferred by thermocompression bonding using a hot-pressing unit such as a heated roller. Then, as shown in FIG. 3D, the intermediate transfer medium 7 is peeled from the transfer target 10. As a result, an image 6b and an image receiving layer 9a are transferred to the transfer target 10, while the area corresponding to the masking layer 3a is left on the intermediate transfer medium 7 without being transferred, forming a void area 10a to which neither of the image nor the image receiving layer is transferred.

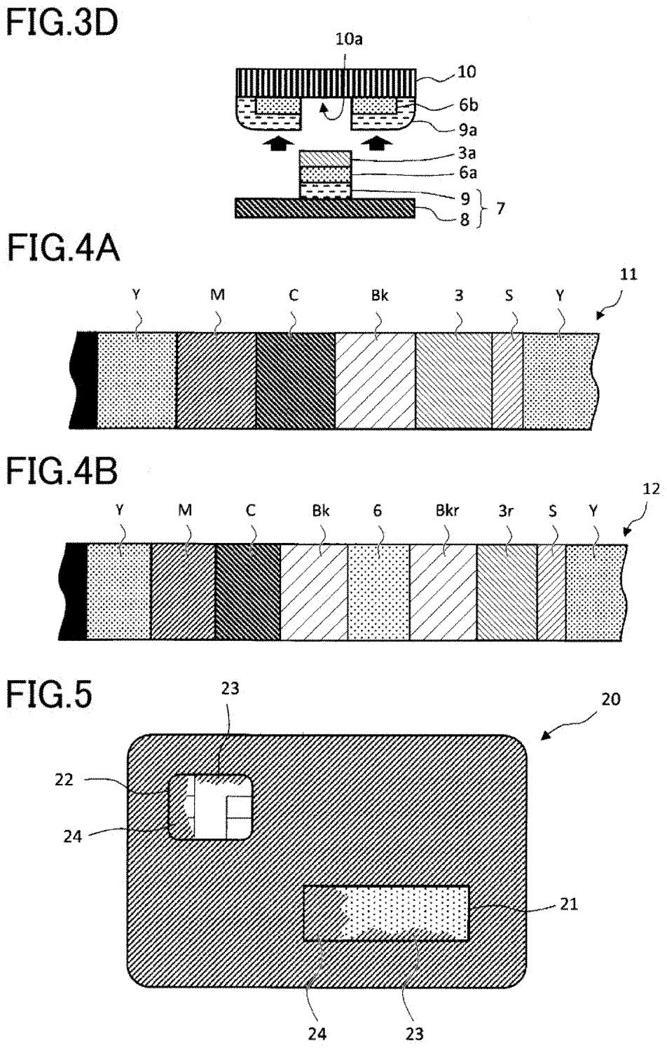

In the thermal transfer sheet according to the present invention, a conventionally known layer serving as a color thermal transfer ink layer, detection marks, a hologram layer, or a protective layer can also be provided on the substrate 2 of the thermal transfer sheet 1 shown in FIG. 1 in parallel with the masking layer 3 on the same surface. Specifically, FIGS. 4A and 4B are plan views illustrating example structures of thermal transfer sheets 11 and 12, respectively, each including the masking layer 3 and color thermal transfer ink layers formed and integrated on the same substrate as described above. More specifically, FIG. 4A illustrates an example in which several color thermal transfer ink layers of yellow Y, magenta M, cyan C, and black Bk, and the masking layer 3 are sequentially arranged across a surface of an elongated substrate and, together with a detection mark S, form a single unit, and multiple units are formed repeatedly. FIG. 4B illustrates an example in which an ink layer of black Bkr and a masking layer 3r for transfer to the rear surface of a card are added to the layers described above.

The thermal transfer sheets 11 or 12 print and form an image and characters from the color thermal transfer ink layer 6 on the image receiving layers 9 or 39 of the intermediate transfer mediums 7 or 37, which are transfer targets.

The above color thermal transfer ink layers include sublimation or melt ink layers, each having a dye layer and a transfer ink layer.

(Dye Layer)

A dye layer may be a conventionally known one. For example, a sublimation dye, which sublimes when heated, a binder, and a solvent are mixed to prepare a coating liquid for forming a dye layer, and application and drying of the coating liquid form a dye layer.

Examples of dyes included in the dye layer include, but not limited to, Solvent Yellow 56, 16, 30, 93 and 33 and Disperse Yellow 201, 231 and 33 as a yellow (Y) component, C.I. Disperse Red 60, C.I. Disperse Violet 26, C.I. Disperse Violet 38, C.I. Solvent Red 27 and C.I. Solvent Red 19 as a magenta (M) component, and C.I. Disperse Blue 354, C.I. Solvent Blue 63, C.I. Solvent Blue 36, C.I. Solvent Blue 266, C.I. Disperse Blue 257 and C.I. Disperse Blue 24 as a cyan (C) component.

The binder resin contained in the dye layer may be a conventionally known binder resin. Examples of the binder resin include, but not limited to, cellulose resins such as ethylcellulose, hydroxyethylcellulose, ethylhydroxycellulose, hydroxypropylcellulose, methylcellulose and cellulose acetate, vinyl resins such as polyvinyl alcohol, polyvinyl acetate, polyvinyl butyral, polyvinyl acetal, polyvinyl pyrrolidone and polyacrylamide, polyester resins, styrene-acrylonitrile copolymer resins, and phenoxy resins.

The mass mixing ratio of the dyes to the binder resin in the dye layer is preferably 10/100 to 300/100. When the mixing ratio of the dyes to the binder resin is below 10/100, the quantity of dyes may be too small, causing insufficient color sensitivity and a failure to provide a good thermal transfer image. When the mixing ratio exceeds 300/100, the solubility of the dyes relative to the binder resin decreases greatly, and the resultant thermal transfer ribbon may have lower storage stability, increasing the likelihood that the dyes will become separated.

The dye layer may also contain known additives such as an isocyanate compound, a silane coupling agent, a dispersant, a viscosity adjuster, and a stabilizer unless they degrade the performance.

The dye layer may also contain a release agent, inorganic fine particles, and organic fine particles. Examples of the release agent include silicone oils, polyethylene waxes, and phosphonate esters. Examples of the silicone oils include straight silicone oils, modified silicone oils, and cured products thereof. The silicone oils may be reactive or non-reactive. Examples of the inorganic fine particles include carbon black, aluminum, and molybdenum disulfide. Modified silicone oils are classified into reactive silicone oils and non-reactive silicone oils. Examples of reactive silicone oils include amino-modified, epoxy-modified, carboxyl-modified, hydroxyl-modified, methacryl-modified, mercapto-modified, phenol-modified, single-end reactive, and dissimilar functional group-modified silicone oils. Examples of non-reactive silicone oils include polyether-modified, methylstyryl-modified, alkyl-modified, higher fatty acid ester-modified, hydrophilic specially modified, higher alkoxyl-modified, and fluorine-modified silicone oils. The amount of added silicone oil is preferably 0.1 to 15% by mass of the mass of the binder, and more preferably 0.3 to 10% by mass. Examples of the organic fine particles include polyethylene wax.

The dye layer may be formed by preparing a coating liquid for the dye layer by dispersing or dissolving the dyes, the binder resin, and various optional components added as appropriate in an appropriate solvent, and applying and drying the coating liquid onto the substrate 5 using a conventionally known coating method. Examples of the conventionally known coating method include solvent coating such as bar coating, blade coating, air knife coating, gravure coating, and roll coating. Examples of the solvent include solvents used for typical coating agents, such as water or organic solvents including alcohols such as methanol, ethanol and isopropyl alcohol, esters such as methyl acetate and ethyl acetate, ketones such as acetone, methyl ethyl ketone and methyl isobutyl ketone, and other hydrocarbons such as toluene, xylene, cyclohexane and dimethylformamide (DMF).

The dye layer may have any thickness, and is typically 0.2 μm to 5 μm.

(Transfer Ink Layer)

The transfer ink layer may be formed by applying and drying a coating liquid prepared by, for example, mixing a dye and/or a pigment, a binder, and a solvent. The transfer ink layer is preferably applied at a dry thickness of about 1.0 μm.

Examples of the dye used for the coating liquid of the transfer ink layer 32 include a wide range of commonly used thermal transfer dyes, such as diarylmethane, triarylmethane, thiazole, methine, azomethane, xanthene, oxazine-based, thiazine, azine, acridine, azo, spirodipyran, isodolinospiropyran, fluoran, rhodaminelactam, and anthraquinone dyes. The pigment may be a known organic pigment or inorganic pigment, such as carbon black, azo, phthalocyanine, quinacridone, thioindigo, anthraquinone, or isoindolinone pigment. Two or more of these may be used in combination.

The binder resin contained in the transfer ink layer 32 is not limited to a particular resin but may be a conventionally known binder resin. Examples of the binder include vinyl resins such as polyvinyl chloride, vinyl chloride-vinyl acetate copolymers, polyvinyl alcohols, polyvinyl acetate, polyvinyl butyral, polyvinyl acetal, polyvinyl pyrrolidone and polyacrylamide, synthetic resins such as polyester resins, phenoxy resins, amide resins, epoxy resins, polyurethane resins, petroleum resins, ionomers, ethylene-acrylic acid copolymers, ethylene-acrylate copolymers and styrene-acrylonitrile copolymers, cellulose resins such as methylcellulose, ethylcellulose, cellulose acetate, nitro cellulose, cellulose acetate propionate, hydroxyethylcellulose, ethylhydroxycellulose and hydroxypropylcellulose, and one or more thermoplastic resins of natural resins and synthetic rubber derivatives such as rosin, rosin-modified maleic resins, ester gum, polyisobutylene rubbers, butyl rubbers, styrene butadiene rubbers, butadiene acrylonitrile rubbers, polyamide resins and polyolefin chloride. Among others, polyvinyl butyral, styrene-acrylonitrile copolymers, and phenoxy resins are suitable.

The transfer ink layer 32 may also contain colorless or light-colored fine particles added in order to improve the thermal transferability, that is, the dot shape for forming a transferred image, and the gradation reproducibility in a manner to avoid impairing the color development of the transferred image as much as possible. Examples of colorless or light-colored fine particles include silica, calcium carbonate, kaolin, clay, starch, zinc oxide, Teflon (registered trademark) powder, polyethylene powder, polymethyl methacrylate resin beads, polyurethane resin beads, and benzoguanamine and melamine resin beads. In particular, silica fine particles are preferable because of a refractive index close to that of resin and good transparency.

The transfer ink layer 32 may also contain an additive such as a release agent, a softening agent, or a surfactant added as appropriate in order to, for example, adjust the thermal sensitivity, the strength, and the adhesiveness of the transfer ink layer 32, in addition to the pigment, the dye, the resin, and the fine particles.

The integrated structure enables an indirect transfer printer to form a color picture and a masking layer on an intermediate transfer medium in a series of steps in the primary transfer process, thus improving efficiency. The size of each ink layer is determined as appropriate in accordance with the size recorded on a transfer target. Furthermore, an ink layer that has not been illustrated may be formed. For example, a UV ink layer or an IR ink layer may be provided. In addition, a detection mark may be provided for each color.

### EXAMPLES

The present embodiment will now be described in more detail with reference to examples.

<Production of Thermal Transfer Sheet>

### Example 1

The coating liquid for a masking layer described below was applied to one surface of a substrate (a PET film with a thickness of 4.5 μm) by gravure coating at a dry thickness of 0.3 and dried for one minute at 80° C. to form a masking layer.

<Coating Liquid for Masking Layer>

| | |
|---|---|
| Cellulose acetate resin (Tg: 160° C.) | 10 parts |
| (L-30, manufactured by Daicel Corporation) | |
| Silicone filler (particle diameter: 2 μm) | 1 part |
| Methyl ethyl ketone | 89 parts |

Thermal transfer sheets in Examples 2 to 5 and Comparative Examples 3 and 4 were produced in the same manner as in Example 1 except that the amount or the particle diameter of the filler were changed. Thermal transfer sheets in Examples 6 and 7 and Comparative Examples 1 and 2 were produced in the same manner as in Example 1 except that the type of the binder resin was changed. Details are listed in table 1.

Color thermal transfer ink layers may be formed after coating liquids for the color thermal transfer ink layers are prepared with the contents listed below. Each coating liquid is applied to the surface of the substrate in parallel with the masking layer at a dry thickness of 0.4 μm, and dried to form a hot-melt color thermal transfer ink layer of the corresponding color.

(Thermal Transfer Ribbon)

<Cyan Ink>

| | |
|---|---|
| Pigment: Phthalocyanine blue | 1.8 parts |
| Resin: Epoxy resin | 3.9 parts |
| Dye: C.I. Solvent Blue 63 | 3.9 parts |
| Colorless fine particles: Silica | 0.4 parts |
| Solvent: Methyl ethyl ketone | 90 parts |

<Magenta Ink>

| | |
|---|---|
| Pigment: Carmine 6B | 1.8 parts |
| Resin: Epoxy resin | 3.9 parts |
| Dye: C.I. Disperse Red 60 | 3.9 parts |
| Colorless fine particles: Silica | 0.4 parts |
| Solvent: Methyl ethyl ketone | 90 parts |

<Yellow Ink>

| | |
|---|---|
| Pigment: Disazo Yellow | 1.8 parts |
| Resin: Epoxy resin | 3.9 parts |
| Dye: C.I. Disperse Yellow 201 | 3.9 parts |
| Colorless fine particles: Silica | 0.4 parts |
| Solvent: Methyl ethyl ketone | 90 parts |

<Transfer to IC Card>

The thermal transfer sheets in Examples 1 to 7 and Comparative Examples 1 to 4 were each used to form an article with an image transferred to it through a commercially available indirect transfer IC card printer. Sticking and burrs in a void area, and rub-off were evaluated. A method for evaluating each evaluation category is described in detail below.

<Evaluation of Sticking to Void Area>

During the transfer to an IC card, a void area was formed in the intermediate transfer medium, and the void area was visually checked for presence or absence of sticking of the intermediate transfer medium.
Good: No sticking of the intermediate transfer medium
Poor: Some sticking of the intermediate transfer medium

<Evaluation of Burrs in Void Area>

Presence or absence of fragments (burrs) of the intermediate transfer medium on the edge of the void area was checked with an optical microscope.
Excellent: Burrs produced with a size of 0 μm to less than 50 μm (longest side)
Good: Burrs produced with a size of 50 μm or more and less than 100 μm (longest side)
Poor: Burrs produced with a size of 100 μm or more (longest side)

<Evaluation of Rub-Off>

After the transfer to the IC card, the inside of the printer was visually checked for presence or absence of adhesion of masking layer fragments. The results are listed in table 1.

TABLE 1

| | | | | | | | | Comp. | Comp. | Comp. | Comp. |
|---|---|---|---|---|---|---|---|---|---|---|---|
| | Ex. 1 | Ex. 2 | Ex. 3 | Ex. 4 | Ex. 5 | Ex. 6 | Ex. 7 | Ex. 1 | Ex. 2 | Ex. 3 | Ex. 4 |
| Type of Resin | Cellulose Acetate | | | | | Polyarylate | Polyacetal | Acryl | Polyamide- | Cellulose | |
| | | | | | | | Propionate | | imide | Acetate | |
| Tg (° C.) | 160 | | | | | 220 | 142 | 100 | 230 | 160 | |
| Thickness of | 0.3 | 0.3 | 0.3 | 1.0 | 0.3 | 0.3 | 0.3 | 0.3 | 0.3 | 0.3 | 0.3 |
| Masking Layer | | | | | | | | | | | |
| (μm) | | | | | | | | | | | |
| Weight | 1% | 20% | 1% | 1% | 1% | 3% | 3% | 1% | 1% | 0% | 30% |
| Percentage of | | | | | | | | | | | |
| Filler | | | | | | | | | | | |
| Filler Particle | 2 | 2 | 0.02 | 2 | 5 | 2 | 2 | 2 | 2 | 0 | 2 |
| Diameter (μm) | | | | | | | | | | | |
| Sticking | Good | Good | Good | Good | Good | Good | Good | Poor | Poor | Good | Good |
| Burrs in Void | Excellent | Excellent | Good | Good | Excellent | Excellent | Excellent | Good | Good | Poor | Good |
| Area | | | | | | | | | | | |
| Rub-off | Good | Good | Good | Good | Good | Good | Good | Good | Good | Good | Poor |

In Examples 1 to 7, the results are good in each of the three evaluation categories. In Example 3, the filler particle diameter that was 0.02 μm caused a slight reduction in the tearing properties of the masking layer, and some burrs were found in the void area. However, the burrs were within tolerance. In Example 4, a thicker masking layer reduced the tearing properties, and some burrs were found in the void area. However, the burrs were within tolerance.

In contrast, the thermal transfer sheet in Comparative Example 1 produced with a binder resin having a Tg of 100° C. achieved good transfer of the masking layer to the intermediate transfer medium (primary transfer). However, during retransfer to the transfer target, the void area and the masking layer adhered to each other, causing sticking. The thermal transfer sheet in Comparative Example 2 produced with a binder resin having a Tg of 230° C. was not transferred due to low adhesion to the intermediate transfer medium during the primary transfer. As a result, no masking layer was formed, as well as no void area being formed. The thermal transfer sheet in Comparative Example 3 produced without adding filler presented poor tearing properties of the masking layer, and burrs were found in the void area. The thermal transfer sheet in Comparative Example 4 produced with 30 wt % filler added relative to the resin had considerably lower adhesion between the substrate and the masking layer, and feeding in the printer was found to cause rub-off.

In the above embodiment, the illustrated intermediate transfer medium 7 includes the image receiving layer 9 provided on the substrate 8. However, this structure is not restrictive, and the intermediate transfer medium 37 shown in FIGS. 6A and 6B may be used. The intermediate transfer medium 37 includes the intermediate layer 32 and the image receiving layer 39 laminated on one surface of the substrate 35. The peeling layer 31, which facilitates peeling, may also be included between the substrate 35 and the intermediate layer 32. In this case, the image 36a is formed through the primary transfer from a sublimation or hot-melt ink layer 36 in the thermal transfer sheet to the image receiving layer 39. When some image area is not to be transferred to the transfer target 40, a masking layer 33 is provided over the area of the ink layer 36 not to be transferred, in order to prevent transfer of the image area (see FIG. 6A). The masking layer 33 is peeled off after an image 36b is formed from the ink layer 36 on the image receiving layer 39 through the secondary transfer (see FIG. 6B).

The masking layer 33 may have the same structure as the masking layer 3, with the binder resin having a Tg of 140° C. or more and 220° C. or less, and 0.5 wt % or more and 20 wt % or less filler particles contained relative to the resin. The dry thickness of the masking layer 33 is preferably 0.1 μm or more and 3 μm or less, and the diameter of the contained filler particles is preferably 0.1 μm or more and 5 μm or less.

### REFERENCE SIGNS LIST

1, 11, 12 . . . Thermal transfer sheet; 2, 5, 8, 35, 38 . . . Substrate; 3, 33 . . . Masking layer; 4 . . . Color thermal transfer sheet; 6 . . . Color thermal transfer ink layer; 7, 37 . . . Intermediate transfer medium; 9, 39 . . . Image receiving layer; 10, 40 . . . Transfer target; 10a . . . Void area; 23 . . . Burr; 24 . . . Sticking portion; 31 . . . Peeling layer; 32 . . . Intermediate layer; 36 . . . Ink layer; 50 . . . Transfer layer.

What is claimed is:

1. A thermal transfer sheet for use in indirect transfer printing for forming an image through primary transfer from the thermal transfer sheet to an intermediate transfer medium and thereafter forming an image on a transfer target through secondary transfer to the transfer target, the thermal transfer sheet, comprising:
a masking layer on a substrate, the masking layer being a portion that prevents transfer to the transfer target during the secondary transfer, wherein
the masking layer is formed from a resin having a Tg of 140° C. or more and 220° C. or less, and
the masking layer contains 0.5 wt % or more and 20 wt % or less filler particles relative to the resin.

2. The thermal transfer sheet of claim 1, wherein
the filler particles contained in the masking layer have a diameter of 0.1 μm or more and 5 μm or less.

3. The thermal transfer sheet of claim 1, wherein
the masking layer has a thickness of 0.1 μm or more and 3 μm or less.

4. The thermal transfer sheet of claim 1, wherein
the masking layer and a plurality of color thermal transfer ink layers are sequentially arranged across a surface of the substrate.

5. An intermediate transfer medium, comprising:
a substrate; and
at least an intermediate layer and an image receiving layer laminated sequentially on one surface of the substrate, wherein
the intermediate transfer medium forms an image through primary transfer from a sublimation ink layer or a hot-melt ink layer in a thermal transfer sheet to the image receiving layer, thereafter forming an image on a transfer target through secondary transfer to the transfer target,
the intermediate transfer medium includes a masking layer formed for the image receiving layer, the masking layer being a portion that prevents transfer to the transfer target and is peeled from the image receiving layer through the secondary transfer after the image is formed from the ink layer onto the image receiving layer,
the masking layer is formed from a resin having a Tg of 140° C. or more and 220° C. or less, and
the masking layer contains 0.5 wt % or more and 20 wt % or less filler particles relative to the resin.

6. The intermediate transfer medium of claim 5, further comprising:
a peeling layer between the substrate and the intermediate layer.

7. The intermediate transfer medium of claim 5, wherein
the filler particles contained in the masking layer have a diameter of 0.1 μm or more and 5 μm or less.

8. The intermediate transfer medium of claim 5, wherein
the masking layer has a thickness of 0.1 μm or more and 3 μm or less.
